(19) United States
(12) Patent Application Publication
(10) Pub. No.: US 2008/0097043 A1
(43) Pub. Date: Apr. 24, 2008

(54) Surface Support Method

(76) Inventor: Jiangdong Tong, Ontario (CA)

Correspondence Address: 3M INNOVATIVE PROPERTIES COMPANY, PO BOX 33427, ST. PAUL, MN, 55133-3427, US

(21) Appl. No.: 11/575,177

(22) PCT Filed: Sep. 19, 2005
(86) PCT No.: PCT/US05/33264

§ 371 Date: Mar. 13, 2007

Related U.S. Application Data
(60) Provisional application No. 60/611,322, filed on Sep. 20, 2004.

(51) Int. Cl. B05D 3/10; C08F 283/00; C08F 283/04; C08G 18/00

(52) U.S. Cl. 525/418; 525/452; 525/535; 427/385.5

(57) ABSTRACT

A method comprises providing a liner to at least a portion of at least one surface, the liner comprising the product of reaction of (a) at least one polymer selected from the group consisting of polyurethanes, polyureas, polythiocarbamates, and combinations thereof; and (b) at least one polymerizable reactive diluent; wherein the surface comprises at least one inorganic mineral other than a metal or a glass, with the proviso that the surface is a surface other than a trafficable surface.

### STATEMENT OF PRIORITY

This application claims the priority of U.S. Provisional Application No. 60/611,322 filed Sep. 20, 2004, the contents of which are hereby incorporated by reference.

### FIELD

The invention relates to a method for providing support to surfaces such as, for example, rock surfaces. The invention also relates to an elastomeric polymeric film that can be used as a load-bearable coating (for example, to assist in protecting from rock bursts in a mine) and to kits for preparing such a film.

### BACKGROUND

Underground mining requires support of the roof and walls of a mine to prevent injury due to rock bursts. A number of materials have been used for this purpose, including shotcrete, wire mesh, and sprayable liner compositions. Both shotcrete and wire mesh are somewhat difficult to handle and apply in underground mines, more particularly in deep mining applications. The application of shotcrete/gunite is labor intensive, and the resulting linings are generally brittle, lacking in significant tensile strength and toughness, and prone to fracturing upon flexing of the rock during mine blasting. In addition, shotcrete/gunite generally develops its desired tensile strength of about 1 MPa only slowly. The sprayable liners that develop strength quickly are often toxic during spray application, whereas liners that have low toxicity during spray application are often not tough enough and generally require more than four hours (at ambient temperature without application of heat) to develop the minimum strength desired to be useful in the mining environment.

### SUMMARY

Thus, we recognize that methods for providing a surface with a tough, flexible, easy-to-apply, and/or quick strength-developable (at ambient temperature) liner system are needed for mining applications, as well as for containment of structural debris resulting from, for example, commercial demolition of a building structure or destruction of a building structure by natural causes or by terrorist activity. The present invention provides such a method, which comprises providing a liner to at least a portion of at least one surface, the liner comprising the product of reaction of
(a) at least one polymer selected from the group consisting of polyurethanes, polyureas, polythiocarbamates, and combinations thereof; and
(b) at least one polymerizable reactive diluent;
   wherein the surface comprises at least one inorganic mineral other than a metal or a glass, with the proviso that the surface is a surface other than a trafficable surface (that is, a surface other than a traffic-bearing surface, for example, such as a highway, bicycle path, or sidewalk used for vehicular or pedestrian traffic). Preferably, the surface comprises at least one material selected from the group consisting of rock, stone, concrete, brick, stucco, and the like, and combinations thereof.

The polymer preferably bears polymerizable reactive groups (more preferably, free-radically polymerizable reactive groups). Preferably, the reactive diluent is a free-radically polymerizable monomer (more preferably, an acryloyl- or methacryloyl-functional monomer).

The liner can have a tensile strength, elongation at break, and thickness sufficient to provide support to exposed surfaces in an excavation. Thus, the liner preferably exhibits a 4-hour Tensile Strength of at least about 1 MPa and/or an elongation at break of at least about 10 percent and/or a thickness of at least about 0.5 mm.

As used herein, the term “liner” means a load-bearable coating that can be applied to a surface (for example, the surfaces of mining cavities, concrete or masonry structures such as buildings and parking garages, highway overpasses and underpasses (for example, bridges and tunnels), and roadsides, for example, to provide support and/or to contain loose or falling debris); and the term “4-hour Tensile Strength” means a tensile strength value that is measured 4 hours after mixing components (a) and (b) according to ASTM D-638-97 (Standard Test Method for Tensile Properties of Plastics, published by American Society for Testing and Materials, West Conshohocken, Pa.) modified by utilizing a crosshead speed of 200 mm per minute, a sample width of 0.635 cm (0.25 inch), and a gauge separation of 5.08 cm (2 inches).

The method of the invention provides a surface with a liner that can exhibit surprising ultimate load-bearing capability (upon complete cure) and, prior to complete cure, generally develops sufficient strength to be useful in a load-bearing capacity (for example in a mining environment) within about 4 hours. A wide range of starting liner components can be utilized in the method and can be easily applied to a surface by spraying (even at low temperatures), yet the resulting composition can cure to provide a tough, flexible coating. In addition, starting liner components of sufficiently low hydrophilicity can be selected so as to provide a liner that is relatively water-resistant and stable to hydrolysis.

In another aspect, the invention provides a liner comprising the product of reaction of:
(a) at least one polymer selected from the group consisting of polyurethanes, polyureas, polythiocarbamates, and combinations thereof;
(b) at least one polymerizable reactive diluent; and
(c) expandable graphite.

In yet another aspect, this invention also provides kits for producing a liner.

A first kit comprises a composition comprising
(a) at least one polymer selected from the group consisting of polyurethanes, polyureas, polythiocarbamates, and combinations thereof; and
(b) at least one polymerizable reactive diluent;
   which, when subjected to reaction conditions, reacts to form a material suitable for use as a liner; wherein the kit further comprises expandable graphite.

A second kit comprises
(a) a first composition comprising at least one polymerizable reactive diluent; and
(b) a second composition comprising at least one polymer that is selected from the group consisting of polyurethanes, polyureas, polythiocarbamates, and combinations thereof, which, when combined with the first composition, reacts to form a material suitable for use as a liner;
   wherein the kit further comprises expandable graphite.

### DETAILED DESCRIPTION

Liner Component (a): Polymer

Polymers suitable for use in the method of the invention include polyurethanes, polyureas, polythiocarbamates, and combinations thereof (for example, polythiocarbamateurethanes, polythiocarbamateureas, polyurethaneureas, and the like) that comprise at least one polycarbonate, polyether, or polyester segment (preferably, polyether). Preferred are polyurethanes, polyureas, and combinations thereof, with polyurethanes being more preferred.

The polymers can be prepared by the reaction of at least one polyisocyanate; at least one hydroxyl-, thio- (that is, mercapto-), or primary or secondary amino-polyfunctional (preferably, hydroxyl- or amino-polyfunctional; more preferably, hydroxyl-polyfunctional) polycarbonate, polyether, or polyester; and, optionally, at least one isocyanate-reactive polyfunctional chain extender. Preferred polymers contain polymerizable reactive groups and can be prepared by the reaction of the foregoing reactants and at least one polymerizable monomer having additional functionality, for example, hydroxyl or amine, that is reactive with isocyanate. The polymerizable monomer preferably is a free-radically polymerizable monomer that contains ethylenic unsaturation.

The polyisocyanates have an average isocyanate functionality of at least about 2 (more preferably, about 2 to about 5; most preferably, about 2). Useful polyisocyanates include aliphatic, alicyclic, and aromatic diisocyanates, and mixtures thereof, with aromatic polyisocyanates generally being preferred. A number of such diisocyanates are commercially available. Representative examples of suitable diisocyanates include hexamethylene diisocyanate (HDI), trimethyl hexamethylene diisocyanate (TMHDI), m- and p-tetramethylxylene diisocyanate (TMXDI), diphenylmethane diisocyanate (MDI), napthalene diisocyanate (NDI), phenylene diisocyanate, isophorone diisocyanate (IPDI), toluene diisocyanate (TDI), bis(4-isocyanatocyclohexyl) methane (H₁₂MDI), and the like, and mixtures thereof.

Useful polyisocyanates also include derivatives of the above-listed monomeric polyisocyanates. These derivatives include, but are not limited to, polyisocyanates containing biuret groups, such as the biuret adduct of hexamethylene diisocyanate (HDI) available from Bayer Corp., Pittsburgh, Pa. under the trade designation Desmodur™ N-100, polyisocyanates containing isocyanurate groups, such as that available from Bayer Corp., Pittsburgh, Pa. under the trade designation Desmodur™ N-3300, as well as polyisocyanates containing urethane groups, uretdione groups, carbodiimide groups, allophonate groups, and the like. If desired, small amounts of one or more polyisocyanates having three or more isocyanate groups can be added to effect a degree of branching.

Preferred polyisocyanates include TDI, MDI, HDI, and mixtures thereof (with TDI, MDI, and mixtures thereof being more preferred).

Useful polycarbonates, polyethers, and polyesters include those which have an equivalent weight in the range of about 250 to about 10,000 (preferably, about 250 to about 5000) and, preferably, a molecular weight from about 500 to about 20,000 (more preferably, from about 500 to about 10,000). Such materials can be utilized to prepare polymers that are useful as liner component (a) having molecular weights that are at least about 5000 (preferably, at least about 10,000; more preferably, at least about 20,000).

Preferred polycarbonates, polyethers, and polyesters have an average amino-(preferably, secondary amino-), thio-, and/or hydroxyl-functionality of at least about 2 (preferably, about 2 to about 5; more preferably, about 2). A number of such functional polymers are commercially available. Diols are preferred due to their availability, low cost, and stability. Representative examples of polymers that are useful (when functionalized in the foregoing manner) include aliphatic polycarbonates such as polyestercarbonates and polyethercarbonates; polyethers such as polyethylene glycol, polypropylene glycol, polybutylene glycol, and polytetrahydrofuran; polyesters such as polycaprolactones, polybutylene adipate, polydiethylene adipate, poly(3-methyl-1,5-pentane) adipate, and poly(neopentyl/1,6-hexane) adipate; and mixtures thereof. Polyethers are preferred because of their flexibility.

Useful chain extenders include low molecular weight (for example, below about 1000, preferably below about 600) polyols, for example, ethylene glycol, 1,2- and 1,3-propanediol, 1,3- and 1,4- and 2,3-butanediol, diethylene glycol, dipropylene glycol, tripropylene glycol, 1,6-hexanediol, 1,4-cyclohexane dimethanol, 3-methyl 1,5-pentanediol, and neopentyl glycol; low molecular weight secondary polyamines, for example, 1,3-di(4-piperidyl)propane (DIPIP), N(2-aminoethyl propylmethyldimethoxysilane (DAS), piperazine, N,N′-dialkyl(methylene)dianiline, N,N′-dialkyl(1,4-diamino)benzene, N,N′-bis(diisopropylmethyl)diaminoethane, and N,N′-bis(t-butyl)diamino cyclohexane; and the like; and mixtures thereof. Although difunctional chain extenders are generally preferred, small amounts of one or more chain extenders having three or more isocyanate-reactive functional groups can be added, if desired.

Suitable polymerizable monomers for use in preparing polymers having polymerizable reactive groups include those that further comprise isocyanate-reactive functionality, for example, hydroxyl or amine functionality. Representative examples of suitable monomers include ethylenically unsaturated monomers such as 2-hydroxyethyl methacrylate, 3-hydroxypropyl methacrylate, 2-hydroxyethyl acrylate, 3-hydroxypropyl acrylate, 4-hydroxybutyl acrylate, 4-hydroxybutyl methacrylate, allyl alcohol, allylethyl alcohol, oleyl alcohol, 4-vinylbenzyl alcohol, and the like, and mixtures thereof. Preferred ethylenically unsaturated monomers are acryloyl- or methacryloyl-functional. Most preferred are 2-hydroxyethyl methacrylate, 3-hydroxypropyl methacrylate, and mixtures thereof.

The polymer can be prepared by first combining at least one hydroxyl-, thio-, or amino-polyfunctional polycarbonate, polyether, or polyester (about 1 equivalent) with at least one isocyanate (about 1 to about 10 equivalents), optionally in the presence of a solvent. If desired, the polymerizable reactive diluent (liner component (b)) described infra can be present at this stage to function as a solvent. The resulting mixture can be allowed to react for about 1 hour at about 40-60° C. under a dry, inert gas atmosphere, generally with stirring. About 0.01% of an organometallic catalyst, for example, of tin or bismuth, can be utilized, as further explained below. Chain extender(s) can then be added to the mixture, if they are utilized. However, the chain extender can be part of the initial mixture (of hydroxyl-, thio-, or amino-polyfunctional polymer and isocyanate) described above, if desired.

The reaction can be allowed to continue for a period of about 3 hours until the isocyanate content is near the theoretical value. Finally, the isocyanate-reactive, polymerizable monomer(s) (if used) can be added (preferably, in an amount that is at least stoichiometrically equivalent to the amount of unreacted isocyanate) and reaction continued for a period of about 2 hours to provide polymer containing polymerizable reactive groups. The resulting polymer preferably has an average reactive group functionality of at least about 2 (more preferably, about 2 to about 5; most preferably, about 2 to about 3).

If polymer without polymerizable reactive groups is desired, chain extender can be included in the reaction mixture (in the absence of isocyanate-reactive polymerizable monomer(s)) in an amount such that the total number of active hydrogen-containing groups (for example, in the chain extender(s) and the polyfunctional polycarbonate(s), polyether(s), or polyester(s)) is at least stoichiometrically equivalent to the total amount of isocyanate. Alternatively, the amounts of chain extender and/or polyfunctional polymer can be reduced and isocyanate-reactive, end-capping agents having no ethylenic unsaturation added.

Preferably, a catalyst is used in preparing the polymer. Catalysts for reacting isocyanates and active hydrogen-containing compounds are well known in the art. Preferred catalysts include organometallic compounds and amines. Useful organometallic compounds include organotin compounds such as dimethyltin dilaurate, dibutyltin dilaurate, dibutyltin dimercaptide, bis lauryl(dibutyltin) oxide, and the like, and mixtures thereof. Zinc or bismuth compounds are also useful. Amine catalysts include tertiary amines, such as, for example, diazobicyclooctane. A preferred catalyst is dibutyltin dilaurate. Catalyst is used in an amount effective to provide a desired reaction rate. Preferably, catalyst is used in an amount of about 0.01-2 percent by weight (more preferably, 0.01-0.03 percent by weight), based on the total weight of solids.

Liner Component (b): Polymerizable Reactive Diluent

Suitable reactive diluents for use in the method of the invention include those that are polymerizable (for example, acrylates, methacrylates, and epoxides). Preferably, the reactive diluent is a free-radically polymerizable monomer (for example, ethylenically-unsaturated monomers such as acrylates, methacrylates, styrene, vinyl acetate, and the like, and mixtures thereof). Preferred monomers include acryloyl- and methacryloyl-functional monomers (hereinafter designated jointly as (meth)acryloyl-functional monomers) such as, for example, alkyl (meth)acrylates, aryloxyalkyl (meth)acrylates, hydroxyalkyl (meth)acrylates, and combinations thereof; more preferably (meth)acryloyl-functional monomers of low odor, for example, having a molecular weight of at least about 150 and/or a vapor pressure of less than about 43 mbar at 20° C. (most preferably less than about 10 mbar at 20° C.). Methacrylates can be preferred over acrylates due to lower volatility.

Representative examples of suitable monomers include methyl acrylate, ethyl acrylate, n-butyl acrylate, isobutyl acrylate, t-butyl acrylate, ethyl methacrylate, butyl methacrylate, ethyltriglycol methacrylate, isobornyl acrylate, 2-(((butylamino)carbonyl)oxy)ethyl acrylate, acetoacetoxyethyl methacrylate, acetoacetoxyethyl acrylate, acetoacetoxypropyl acrylate, acetoacetoxybutyl acrylate, 2-methyl-2-(3-oxo-butyrylamino)-propyl methacrylate, 2-ethylhexyl acrylate, n-octyl acrylic acetate, decyl acrylate, lauryl acrylate, stearyl acrylate, 2-hydroxyethyl acrylate, 2-hydroxypropyl acrylate, 2-hydroxyethyl methacrylate, 2-hydroxypropyl methacrylate, β-ethoxyethyl acrylate, 2-cyanoethyl acrylate, cyclohexyl acrylate, diethyl aminoethyl acrylate, hexyl methacrylate, decyl methacrylate, tetrahydrofurfuryl methacrylate, lauryl methacrylate, stearyl methacrylate, phenylcarbitol acrylate, nonylphenyl carbitol acrylate, nonylphenoxy propyl acrylate, 2-phenoxyethyl methacrylate, 2-phenoxypropyl methacrylate, N-vinyl pyrrolidone, polycaprolactam acrylate, acryloyloxyethyl phthalate, acryloyloxy succinate, 2-ethylhexyl carbitol acrylate, ω-carboxy-polycaprolactam monoacrylate, phthalic acid monohydroxyethyl acrylate, styrene, vinyl acetate, vinyl toluene, α-methyl styrene, acrylonitrile, glycidyl methacrylate, n-methylol acrylamide-butyl ether, n-methylol acrylamide, acrylamide, dicyclopentenyloxyethyl acrylate, dicyclopentenyl acrylate, dicyclopentenyloxyethyl acrylate, and the like, and mixtures thereof.

Preferred monomers include isobornyl acrylate, isobornyl methacrylate, decyl acrylate, lauryl acrylate, stearyl acrylate, 2-hydroxyethyl methacrylate, 2-hydroxypropyl methacrylate, decyl methacrylate, tetrahydrofurfuryl methacrylate, lauryl methacrylate, stearyl methacrylate, phenylcarbitol acrylate, nonylphenyl carbitol acrylate, nonylphenoxy propyl acrylate, 2-phenoxyethyl methacrylate, 2-phenoxypropyl methacrylate, and the like, and mixtures thereof, with tetrahydrofurfuryl methacrylate, 2-phenoxyethyl methacrylate, 2-phenoxypropyl methacrylate, 2-hydroxyethyl methacrylate, 2-hydroxypropyl methacrylate, and mixtures thereof being more preferred.

If desired, small amounts of multifunctional ethylenically unsaturated monomer(s) (compounds possessing at least two polymerizable double bonds in one molecule, for example, multifunctional acrylates or methacrylates) can be utilized to, for example, effect crosslinking. Representative examples of such multifunctional monomers include ethylene glycol diacrylate; 1,2-propylene glycol diacrylate; 1,3-butylene glycol diacrylate; 1,6-hexanediol diacrylate; neopentylglycol diacrylate; trimethylolpropane triacrylate; polyoxyalkylene glycol diacrylates such as dipropylene glycol diacrylate, triethylene glycol diacrylates, tetraethylene glycol diacrylates, polyethylene glycol diacrylate; ethylene glycol dimethacrylate; 1,2-propylene glycol dimethacrylate; 1,3-butylene glycol dimethacrylate; 1,6-hexanediol dimethacrylate; neopentylglycol dimethacrylate; bisphenol-A-dimethacrylate; diurethane dimethacrylate; trimethylolpropane trimethacrylate; polyoxyalkylene glycol dimethacrylates such as dipropylene glycol dimethacrylate, triethylene glycol dimethacrylates, tetraethylene glycol dimethacrylates, polyethylene glycol dimethacrylate; N,N-methylene-bis-methacrylamide; diallyl phthalate; triallyl phthalate; triallyl cyanurate; triallyl isocyanurate; allyl acrylate; allyl methacrylate; diallyl fumarate; diallyl isophthalate; diallyl tetrabromophthalate; ditrimethylolpropane tetraacrylate; dipentaerythritol pentaacrylate; and the like; and mixtures thereof.

Preparation and Use of Liner

In carrying out the method of the invention, the polymer (component (a)) and the polymerizable reactive diluent (component (b)) (and, optionally, at least one initiator) can be applied to a surface (preferably, in a manner that does not permit the premature reaction of one or both components) and the resulting mixture allowed to react. (Alternatively, but less preferably, intermediates that are capable of reaction to form one or more of the components (or to form the final product) can be applied to the surface, or the liner can be preformed and then applied to the surface.) Generally, the weight ratio of component (a) to component (b) can be in the range of about 10:1 to about 1:10. Preferably, component (a) can be dissolved in component (b).

An initiator is preferably included (more preferably, along with at least one accelerator) in the liner composition, so that initiating species can be relatively rapidly generated. This enables “fast set” or “quick strength development” characteristics that are often desirable in containment applications.

Although the liner can be cured by exposure to ultraviolet (if the composition is only lightly filled) or electron beam radiation, thermal curing is generally preferred. If radiation curing is utilized, one or more photoinitiators, for example, benzophenone can be added, if necessary or desired, for example, in amounts ranging from about 0.05 to about 5 weight percent (based upon the total weight of all liner components). Representative examples of suitable photoinitiators include 2,2-dimethoxy-1,2-diphenylethane-1-one, 2-methyl-1-[4-(methylthio)phenyl]-2-morpholinopropanone-1, benzophenone, and the like, and mixtures thereof.

Preferably, however, a curing system comprising a thermally-activatable initiator (and, more preferably, an accelerator) is utilized (for example, in amounts of from about 0.01 or 0.5 to about 5 or 10 weight percent of each, based upon the total weight of all liner components). Useful thermally-activatable initiators include organic peroxides, for example, diacyl peroxides, dialkyl peroxides, hydroperoxides, ketone peroxides, and the like, and mixtures thereof.

The accelerator of the curing system, if an accelerator is used, functions to decompose the initiator through, for example, a redox reaction, thereby facilitating the generation of active radicals. (Alternatively, heat and pressure can be utilized to accelerate reaction.) Useful accelerators include metal salts, for example, cobalt naphthenate and vanadium octoate; mercaptans, for example, glycol dimercaptoacetate; tertiary amines, for example, dimethyl-p-toluidine, diisopropoxy-p-toluidine, diethyl-p-toluidine, dimethyl aniline, and aniline butyraldehyde condensate; and the like; and mixtures thereof. Preferred accelerators are tertiary amines.

The kits of the invention can comprise one, two, or more compositions, depending upon the nature of the components and the need or desire for component separation. The accelerator can be included in a kit composition that does not contain initiator. For example, the accelerator can be included in the kit composition that also contains the reactive diluent, with the initiator being included in a kit composition that does not contain reactive diluent. The initiator and the reactive diluent can preferably be kept in separate kit compositions and then brought together for the first time just prior to application to a surface. If initiator and/or accelerator are not utilized, then the liner components can be combined in a single kit composition, if desired.

The liner provided according to the method of the invention is preferably gas-tight and flexible. The liner preferably has an elongation at break (measured according to ASTM D-638-97) of from about 10 to about 1000%, more preferably from about 30 to about 800%, even more preferably from about 50 to about 400%, most preferably from about 100 to about 300%. The liner is, preferably, a cross-linked mass having a high degree of flexibility. Preferably, the liner does not significantly swell upon contact with water.

In addition to flexibility, the liner exhibits toughness. Preferably, the liner exhibits a 4-hour Tensile Strength of at least about 1 MPa (more preferably, at least about 2 MPa; even more preferably, at least about 3 MPa; most preferably, at least about 4 MPa).

The liners produced according to the method of the invention can be used as load-bearable coatings to support, for example, rock surfaces in a mine. For such applications, the liners are preferably thick (at least about 0.5 mm; preferably, up to about 6 mm or even 10 mm or more) when cured completely.

Other additive ingredients can be included in the liner. For example, viscosity modifiers can be included to increase or decrease the viscosity, depending on the desired application technique. Fungicides can be added to prolong the life of the liner and to prevent attack by various fungi. Other active ingredients can be added for various purposes, such as substances to prevent encroachment of plant roots, and the like. Other additives that can be included in the liner, include, without limitation, rheological additives, emulsifiers, plasticizers, fillers, fire retardants, smoke retardants, defoamers, and coloring agents. Care should be exercised in choosing fillers and other additives to avoid any materials that will have a deleterious effect on the viscosity, the reaction time, the stability of the liner being prepared, and the mechanical strength of the resulting liner.

The additional filler materials that can be included in the liner can provide a more shrink-resistant, substantially incompressible, and fire retardant liner. Any of a number of filler compositions can be effective. Useful fillers include particulate filler material having a particle size of about less than 500 microns, preferably about 1 to 50 microns, and a specific gravity in the range of about 0.1 to 4.0, preferably about 1.0 to 3.0. The filler content of the cured liner can be as much as about 10 parts filler per 100 parts by weight cured liner, preferably about 5 parts to about 10 parts per 100.

Examples of useful fillers include expandable graphite (for example, graphite that expands upon application of heat) such as GRAFGUARD 220-80B or GRAFGUARD 160-150B (Graftech, Ohio, USA); silica such as quartz, glass beads, glass bubbles, and glass fibers; silicates such as talc, clays, (montmorillonite) feldspar, mica, calcium silicate, calcium metasilicate, sodium aluminosilicate, and sodium silicate; metal sulfates such as calcium sulfate, barium sulfate, sodium sulfate, aluminum sodium sulfate, and aluminum sulfate; gypsum; vermiculite; wood flour; aluminum trihydrate; carbon black; aluminum oxide; titanium dioxide; cryolite; chiolite; and metal sulfites such as calcium sulfite. Preferred fillers include expandable graphite, feldspar, and quartz. The filler is most preferably expandable graphite. The amount of filler added to the liner can preferably be chosen so that there is no significant effect on elongation or tensile strength of the resulting liner. Such amounts can be determined by routine investigation.

When filler is utilized, the resulting liner can also be fire retardant (and, if expandable graphite is the filler, can exhibit some self-extinguishment characteristics). For some applications, the liner preferably can meet the fire retardant specifications of CAN/ULC-S102-M88 or ASTM E-84. These tests determine burn rate and the amount of smoke generation.

The starting components of the liner are preferably mixed immediately before being applied to a non-trafficable surface comprising or consisting essentially of at least one inorganic mineral other than a metal or a glass (preferably, a non-trafficable surface comprising or consisting essentially of at least one material selected from the group consisting of rock, stone, concrete, brick, stucco, and the like, and combinations thereof; more preferably, the group consisting of rock, stone, and the like, and combinations thereof; even more preferably, a surface in an excavation; most preferably, a surface in a mine). As an example of the mixing process, the components can be pumped using positive displacement pumps and then mixed in a static mixer before being sprayed onto a surface. The mixture can then be sprayed onto a substrate with or without air pressure. The mixture can preferably be sprayed without the use of air. The efficiency of mixing depends on the length of the static mixer. Useful application equipment includes, for example, a pump manufactured by Gusmer Canada, Ontario, Canada, as Model H-20/35, having a 2-part proportioning high pressure spray system that feeds through a heated temperature controlled (for example, 50° C.) zone to an air purging impingement mixing spray head gun of, for example, type GAP (Gusmer Air Purge) also manufactured by Gusmer.

### EXAMPLES

Objects and advantages of this invention are further illustrated by the following examples, but the particular materials and amounts thereof recited in these examples, as well as other conditions and details, should not be construed to unduly limit this invention.

### Liner Preparation Procedure

Liners are prepared by mixing the Part A and Part B materials described in the numbered examples below (which are stored in separate cartridges) using an air-powered dispensing gun (3M™ EPX™ Applicator, available from 3M Company, St. Paul, Minn.) and an 18-element static mixer. The resulting mixture is injected into a poly(tetrafluoroethylene)-lined, stainless steel mold to make a film of 3×50×200 mm.

### Example 1

Part A is a mixture of 60 g of CN9782 difunctional acryloyl-terminated polyurethane (Sartomer, Exton, Pa.), 20 g of phenoxyethyl methacrylate (Sartomer), 20 g of 2-hydroxypropyl methacrylate (Sartomer), and 1 g of N,N-dimethyl-p-toluidine (Sigma-Aldrich Canada, Oakville, Ontario). Part B is a mixture of 60 g of CN9782, 20 g of ethoxylated bisphenol A dimethacrylate (Sartomer), 20 g of 2-hydroxypropyl methacrylate (Sartomer), and 1 g of benzoyl peroxide (Sigma-Aldrich Canada).

### Example 2

Part A is a mixture of 70 g of CN972 trifunctional acryloyl-terminated polyurethane (Sartomer, Exton, Pa.), 15 g of phenoxyethyl methacrylate (Sartomer), 15 g of 2-hydroxypropyl methacrylate (Sartomer), and 1 g of N,N-dimethyl-p-toluidine (Sigma-Aldrich Canada, Oakville, Ontario). Part B is a mixture of 70 g of CN972, 15 g of ethoxylated bisphenol A dimethacrylate (Sartomer), 15 g of 2-hydroxypropyl methacrylate (Sartomer), and 1 g of benzoyl peroxide (Sigma-Aldrich Canada).

The referenced descriptions contained in the patents, patent documents, and publications cited herein are incorporated by reference in their entirety as if each were individually incorporated. Various unforeseeable modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

We claim:

1. A method comprising providing a liner to at least a portion of at least one surface, said liner comprising the product of reaction of
(a) at least one polymer selected from the group consisting of polyurethanes, polyureas, polythiocarbamates, and combinations thereof; and
(b) at least one polymerizable reactive diluent;
wherein said surface comprises at least one inorganic mineral other than a metal or a glass, with the proviso that said surface is a surface other than a trafficable surface.

2. The method of claim 1, wherein said surface comprises at least one material selected from the group consisting of rock, stone, concrete, brick, stucco, and combinations thereof.

3. The method of claim 2, wherein said surface comprises at least one material selected from the group consisting of rock, stone, and combinations thereof.

4. The method of claim 1, wherein said surface is a surface in an excavation.

5. The method of claim 1, wherein said surface is a surface in a mine.

6. The method of claim 1, wherein said polymer is selected from the group consisting of polyurethanes, polyureas, and combinations thereof.

7. The method of claim 6, wherein said polymer is a polyurethane.

8. The method of claim 1, wherein said polymer comprises polymerizable reactive groups.

9. The method of claim 8, wherein said polymerizable reactive groups are free-radically polymerizable groups.

10. The method of claim 9, wherein said free-radically polymerizable groups are selected from the group consisting of acryloyl groups, methacryloyl groups, and mixtures thereof.

11. The method of claim 8, wherein said polymer has an average polymerizable group functionality of at least about 2.

12. The method of claim 1, wherein said polymer comprises at least one polycarbonate, polyester, or polyether segment.

13. The method of claim 12, wherein said segment is a polyether segment.

14. The method of claim 1, wherein said reactive diluent is a free-radically polymerizable monomer.

15. The method of claim 14, wherein said free-radically polymerizable monomer is selected from the group consisting of acryloyl-functional monomers, methacryloyl-functional monomers, and mixtures thereof.

16. The method of claim 1, wherein said liner further comprises expandable graphite.

17. The method of claim 1, wherein said liner exhibits a 4-hour Tensile Strength of at least about 1 MPa.

18. The method of claim 1, wherein said liner exhibits an elongation at break of at least about 10 percent.

19. The method of claim 1, wherein said liner has a thickness of at least about 0.5 mm.

20. A method comprising
(a) applying to at least a portion of at least one surface that comprises at least one material selected from the group consisting of rock, stone, concrete, brick, stucco, and combinations thereof
(1) at least one polymer that is selected from the group consisting of polyurethanes, polyureas, and combinations thereof, which comprises at least one polyether segment, which contains free-radically polymerizable groups, and which has an average polymerizable group functionality of at least about 2; and
(2) at least one free-radically polymerizable monomer; and
(b) allowing the applied components to react to form a liner comprising the reaction product of said applied components;
wherein said surface is a surface other than a trafficable surface.

21. The method of claim 20, wherein said surface comprises at least one material selected from the group consisting of rock, stone, and combinations thereof.

22. The method of claim 20, wherein said surface is a surface in an excavation.

23. The method of claim 20, wherein said surface is a surface in a mine.

24. The method of claim 20, wherein said polymer is a polyurethane.

25. The method of claim 20, wherein said free-radically polymerizable monomer is selected from the group consisting of acryloyl-functional monomers, methacryloyl-functional monomers, and mixtures thereof.

26. The method of claim 20, wherein said liner exhibits a 4-hour Tensile Strength of at least about 1 MPa, an elongation at break of at least about 10 percent, and a thickness of at least about 0.5 mm.

27. A liner comprising the product of reaction of:
(a) at least one polymer selected from the group consisting of polyurethanes, polyureas, polythiocarbamates, and combinations thereof;
(b) at least one polymerizable reactive diluent; and
(c) expandable graphite.

28. A mine that is at least partially lined with a liner formed by the method of claim 1.

29. A mine that is at least partially lined with a liner formed by the method of claim 20.

30. A mine that is at least partially lined with the liner of claim 27.

31. A building structure having at least one non-trafficable surface that is at least partially lined with a liner prepared by the method of claim 1.

32. A building structure having at least one non-trafficable surface that is at least partially lined with a liner prepared by the method of claim 20.

33. A building structure having at least one non-trafficable surface that is at least partially lined with the liner of claim 27.

34. A kit comprising a composition comprising
(a) at least one polymer selected from the group consisting of polyurethanes, polyureas, polythiocarbamates, and combinations thereof; and
(b) at least one polymerizable reactive diluent;
which, when subjected to reaction conditions, reacts to form a material suitable for use as a liner; wherein said kit further comprises expandable graphite.

35. A kit comprising
(a) a first composition comprising at least one polymerizable reactive diluent; and
(b) a second composition comprising at least one polymer that is selected from the group consisting of polyurethanes, polyureas, polythiocarbamates, and combinations thereof, which, when combined with said first composition, reacts to form a material suitable for use as a liner;
wherein said kit further comprises expandable graphite.
